(19) United States
(12) Patent Application Publication
(10) Pub. No.: US 2014/0085164 A1
(43) Pub. Date: Mar. 27, 2014

(54) ANTENNA DEVICE AND ELECTRONIC APPARATUS WITH THE ANTENNA DEVICE

(71) Applicant: Kabushiki Kaisha Toshiba, Tokyo (JP)

(72) Inventors: Ippei Kashiwagi, Fuchu-shi (JP); Hiroyuki Hotta, Ome-shi (JP)

(73) Assignee: Kabushiki Kaisha Toshiba, Tokyo (JP)

(21) Appl. No.: 14/015,636

(22) Filed: Aug. 30, 2013

Related U.S. Application Data
(63) Continuation of application No. PCT/JP2013/057305, filed on Mar. 14, 2013.

(30) Foreign Application Priority Data
Sep. 26, 2012 (JP) 2012-212637

(51) Int. Cl. H01Q 21/00

(52) U.S. Cl. CPC H01Q 21/00
USPC 343/893

(57) ABSTRACT

An antenna device of an embodiment includes first and second antenna elements arranged along a side of a patterned ground, and a T-shaped passive element. The first antenna element has a first end connected to a first feed point, and an open second end. A part of the first antenna element including the second end is positioned parallel to the side of the ground. The second antenna element has a first end connected to a second feed point, and an open second end. A part of the second antenna element including the second end is positioned parallel to the side of the ground. A passive element has a common portion connected to the ground between the first and second feed points, and has first and second branches positioned to be able to be capacitively coupled to the parts.

### CROSS REFERENCE TO RELATED APPLICATIONS

This application is a Continuation Application of PCT Application No. PCT/JP2013/057305, filed Mar. 14, 2013 and based upon and claiming the benefit of priority from Japanese Patent Application No. 2012-212637, filed Sep. 26, 2012, the entire contents of all of which are incorporated herein by reference.

### FIELD

Embodiments described herein relate generally to an antenna apparatus and an electronic device with the antenna device.

### BACKGROUND

Various types of electronic devices have recently been developed in which a wireless interface for utilizing a wireless network, such as 3G/LTE (Third-generation cellular phone/Long Term Evolution), a wireless LAN (Wireless Local Area Network), WiMAX (trademark), UWB (Ultra Wideband), or Bluetooth (trademark), is built in a personal computer or a television terminal, which interface enables various types of content and data to be downloaded from, for example, a Web site.

Among the antenna devices for the wireless interface, there is an antenna device for realizing a spatial diversity or MIMO (Multiple Input Multiple Output). For the spatial diversity or MIMO, a plurality of antennas arranged at intervals are used. When such an antenna device is contained in an electronic device, it is necessary to secure a container space broader than in the case of using a single antenna. On the other hand, such an electronic device as a personal computer or a tablet type terminal has only a limited space in its housing because of thinning of the housing or high-density packaging of circuit components. In light of this, an electronic device, in which a plurality of antennas are arranged in part of, for example, its frame-shaped housing that supports a display, has been proposed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an electronic apparatus with an antenna device according to a first embodiment;

FIG. 2 is a view illustrating the structure of the antenna device of the first embodiment;

FIG. 3 is a view illustrating an antenna current path in the antenna device of FIG. 2;

FIG. 4 is a graph illustrating the VSWR characteristic of the antenna device of FIG. 2;

FIG. 5 is a graph illustrating the VSWR characteristic of a reference example in which a high-frequency cable is located on a single band antenna;

FIG. 6 is a graph illustrating a comparison result between the VSWR characteristic of the antenna device of FIG. 2 and that of a conventional antenna device;

FIG. 7 is a graph illustrating a comparison result between the radiation efficiency characteristic of the antenna shown in FIG. 2 and that of the conventional antenna device;

FIG. 8 is a view illustrating the structure of an antenna device according to a second embodiment;

FIG. 9 is a graph illustrating frequency characteristic associated with the coupled amount of a first antenna element and a second antenna element included in the antenna device of FIG. 8;

FIG. 10 is a perspective view illustrating an electronic apparatus according to a third embodiment;

FIG. 11 is a graph illustrating the VSWR characteristic of a second antenna element included in the antenna device of FIG. 10; and

FIG. 12 is a graph illustrating the VSWR characteristic of a second antenna element obtained from a reference example wherein a high-frequency cable for MIMO antennas is located on the second antenna element.

### DETAILED DESCRIPTION

Descriptions will be given of embodiments with reference to the accompanying drawings.

In general according to one embodiment, an antenna device for use in an electronic device comprises a wireless circuit unit, a patterned ground providing a ground potential, and a first feed point and a second feed point arranged along a side of the patterned ground with a predetermined distance therebetween, comprising:

a first antenna element comprising a first end connected to the first feed point and a second end kept open, a part of the first antenna element comprising the open second end being positioned parallel to the side of the patterned ground;

a second antenna element adjacent to the first antenna element along the side of the patterned ground, and comprising a first end connected to the second feed point and a second end kept open, a part of the second antenna element comprising the open second end being positioned parallel to the side of the patterned ground;

a T-shaped passive element comprising a common portion, and a first branch portion and a second branch portion branching off from the common portion, an end of the common portion being connected to the patterned ground between the first and second feed points, the first and second branch portions being positioned to be able to be capacitively coupled to the respective parts of the first and second antenna elements comprising the second ends;

a first high-frequency cable connecting the first feed point to the wireless circuit unit; and

a second high-frequency cable connecting the second feed point to the wireless circuit unit,

wherein the first and second high-frequency cables are led in a same direction from the first and second feed points, respectively, along the side of the patterned ground, and the first high-frequency cable is extended on the patterned ground.

### First Embodiment

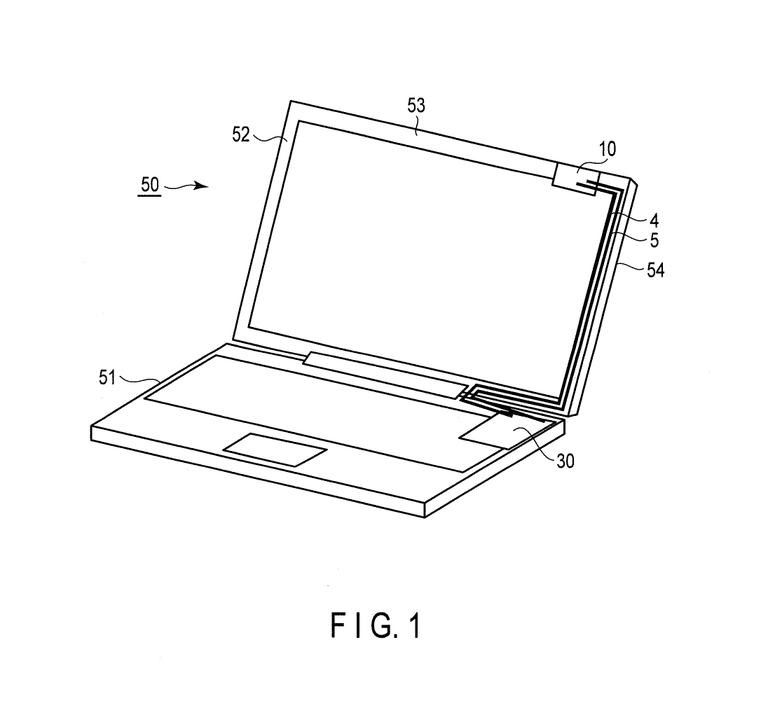

FIG. 1 is a perspective view illustrating an electronic apparatus with an antenna device according to a first embodiment.

The electronic device of the first embodiment is, for example, a notebook personal computer 50. It may be a portable terminal other than the notebook personal computer or a television receiver, e.g., a navigation terminal, a cellular phone, a smart phone, a personal digital assistant (PDA) or a tablet terminal.

A first wireless circuit 30 is contained in a lower housing 51 incorporated in the notebook personal computer 50. An upper housing 52 incorporated in the notebook personal computer 50 is in the form of a frame to support a display. The frame-shaped upper housing 52 has an upper portion 53 that contains a MIMO (multiple input multiple output) antenna device 10. The MIMO antenna device 10 is located near an end of the upper portion 53 of the upper housing 52.

The MIMO antenna device 10 is used as a transceiver for, for example, a wireless LAN (local area network), and comprises a plurality of antenna elements. These antenna elements are connected to the first wireless circuit 30 by first and second high-frequency cables (RF cables) 4 and 5. The first and second RF cables 4 and 5 are extended from the MIMO antenna device 10 parallel to each other to the first wireless circuit 30 of the lower housing 51 along the upper portion 53 of the upper housing 52 and along one side 54 of the upper housing 52.

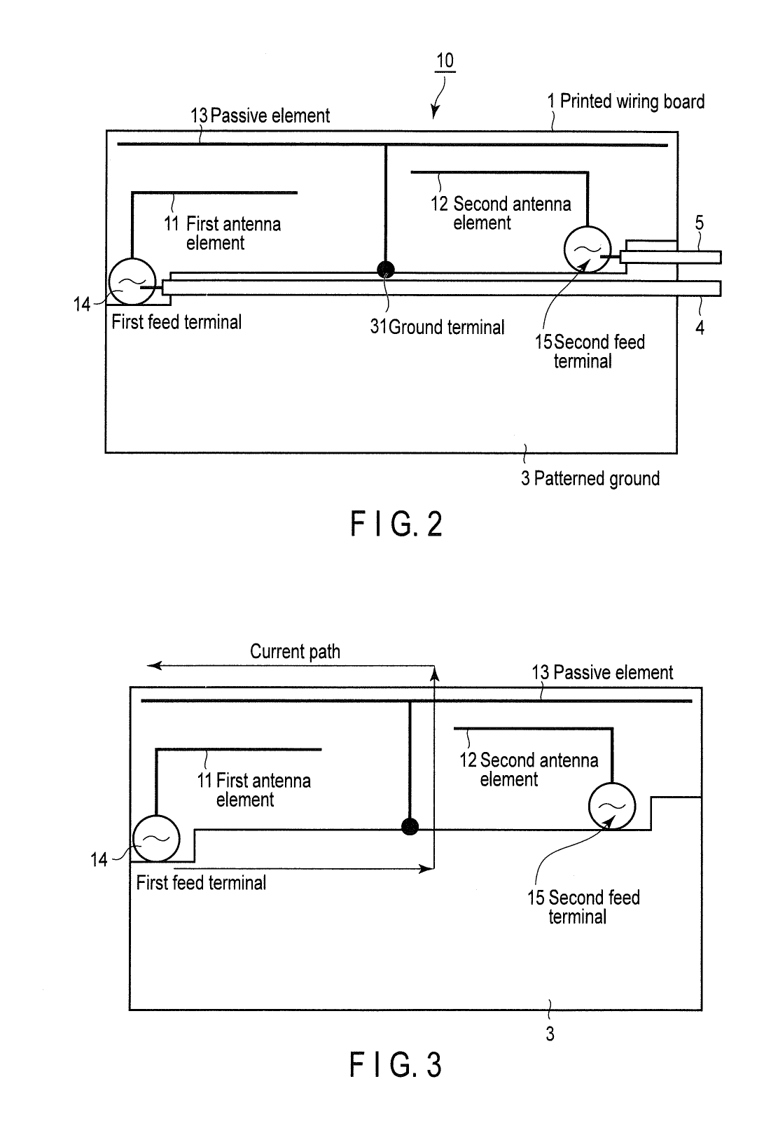

FIG. 2 is a view illustrating the structure of the MIMO antenna device 10. As shown, the MIMO antenna device 10 is provided on a printed wiring board 1 with a patterned ground 3 thereon, and comprises a first antenna element 11, a second antenna element 12, a passive element 13, a first feed terminal 14 and a second feed terminal 15. The first and second feed terminals 14 and 15 are provided along one side of the patterned ground 3 near the opposite ends of the printed wiring board 1.

The first antenna element 11 is a linear monopole element in the form of an inverted L, and has one end connected to the first feed terminal 14, and the other end kept open. Similarly, the second antenna element 12 is a linear monopole element in the form of an inverted L, and has one end connected to the second feed terminal 15, and the other end kept open. The open ends of the first and second antenna elements 11 and 12 face each other. The lengths of the first and second antenna elements 11 and 12 are set so that the antenna elements will resonate with a first frequency band f1 of, for example, 5 GHz. As a result, the first and second antenna elements 11 and 12 operate as MIMO antennas dedicated to the first frequency band (f1=5 GHz).

The passive element 13 is a linear element in the form of T, and has its proximal end connected to a ground terminal 31 provided on the patterned ground 3. The ground terminal 31 is located between the first and second feed terminals 14 and 15. That is, the ground terminal 31 is remote from second feed terminal 15 and is positioned at a side of the first feed terminal 14, and the ground terminal 31 is also remote from first feed terminal 14 and is also positioned at a side of the second feed terminal 15.

As shown in FIG. 2, the branch portions of the T-shaped passive element 13 are positioned parallel with the horizontal portions of the first and second antenna elements 11 and 12 with predetermined gaps defined therebetween, whereby the branch portions are capacitively coupled to the horizontal portions. The length of from the ground terminal 31 of the passive element 13 to the distal end of one branch portion of the passive element 13 is set so that the passive element 13 will resonate with a second frequency band f2 of, for example, 2.5-3 GHz.

The branch portions of the T-shaped linear pattern may not be horizontally symmetrical. Namely, the linear passive element 13 may not strictly be T-shaped.

As shown in FIG. 2, the patterned ground 3 is so step wisely formed as to have stepwise portions. More specifically, a cut-off portion is provided on the patterned ground 3, which is located on the left side of the printed wiring board 1 and on which the first feed terminal 14 is provided. The cut-off portion has a certain length from the left end of the printed wiring board 1 to the center portion of the board 1 where the ground terminal 31 is provided. Further, a protruded portion is provide on the right side of the printed wiring board 1, which is protruded and extended, by a certain length, from the right end of the printed wiring board 1 to the center portion of the board 1 where the ground terminal 31 is provided. The first RF cable 4 has its one end connected to the first feed terminal 14, is extended on the stepwise portion of the patterned ground 3 and is led out of the wiring board. The second RF cable 5 has its one end connected to the second feed terminal 15, is extended on the stepwise portion of the patterned ground 3 and is led out in the same direction as the first RF cable 4 in parallel therewith.

Thus, the first RF cable 4 is not extended on or near the second antenna element 12, but is led out through the stepwise portion of the patterned ground 3. This can suppress adverse influence of the first RF cable 4 upon the second antenna element 12 to thereby suppress occurrence of unnecessary resonance and deviation in resonance frequency.

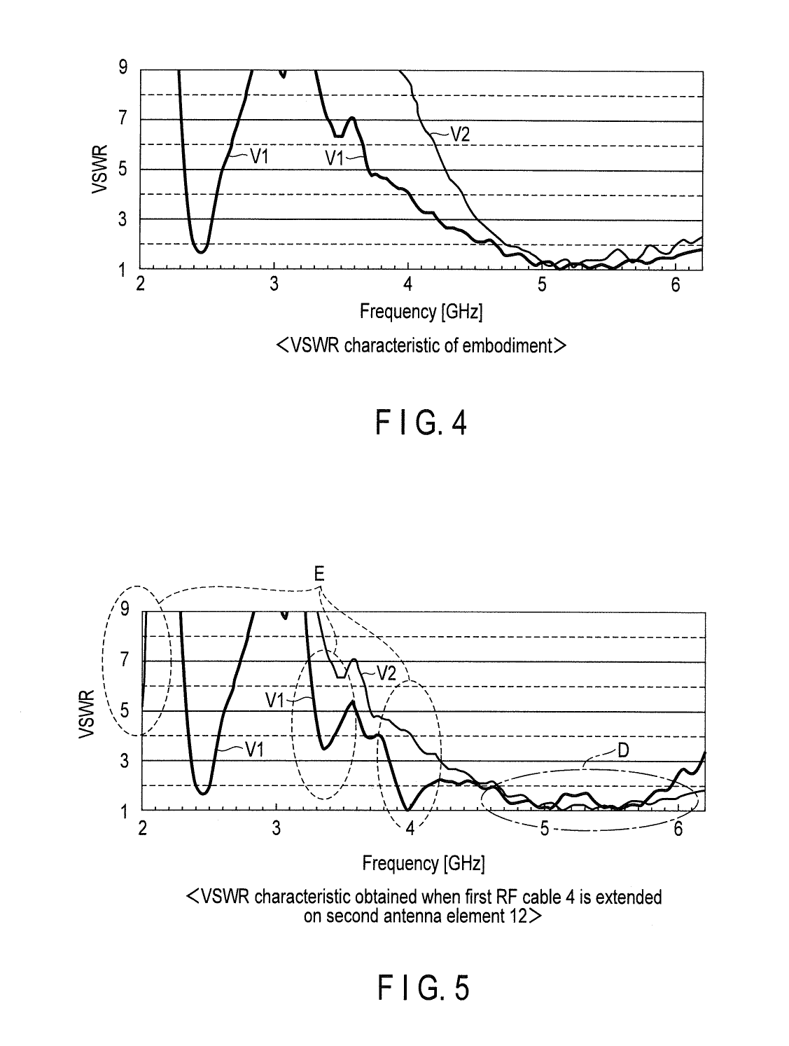

FIG. 4 is a graph illustrating an example of the voltage standing wave ratio (VSWR) characteristic (frequency characteristic) V1 of the first antenna element 11 and the passive element 13, and an example of the VSWR characteristic (frequency characteristic) V2 of the second antenna element 12. As can be understood from FIG. 4, occurrence of unnecessary resonance is suppressed in the characteristics V1 and V2.

If the first RF cable 4 is extended on the second antenna element 12, unnecessary resonance phenomena E and frequency deviation D is produced due to the first RF cable 4 and are detected in the VSWR characteristic of the second antenna element 12 as shown in, for example, FIG. 5. Therefore, in this case, it is difficult to obtain desired antenna characteristics.

Further, in the first embodiment, the passive element 13 is T-shaped, and its left branch portion is arranged parallel to the first antenna element 11 at the position at which capacitive coupling is possible. Similarly, the right branch portion is arranged parallel to the second antenna element 12 at the position at which capacitive coupling is possible. Thus, the first antenna element 11 and the left branch portion of the passive element 13 cooperate to constitute a first antenna unit of dual mode with two resonance frequency bands f1 and f2, while the second antenna element 12 and the right branch portion of the passive element 13 cooperate to constitute a second antenna unit of dual mode with the two resonance frequency bands f1 and f2. Namely, simply by providing the T-shaped passive element 13 between the first and second antenna elements 11 and 12, a MIMO antenna device of dual mode with the two resonance frequency bands f1 and f2 can be provided.

Further, the antenna current output from the first and second feed terminals 14 and 15 to the patterned ground 3 flows along one side of the patterned ground 3, and then flows through the ground terminal 31 into the right and left branch portions of the passive element 13 via the common portion of the same. Thus, the right and left branch portions of the passive element 13 function as stubs when referred from the first and second feed terminals 14 and 15, thereby more reliably suppressing coupling of the first and second antenna elements 11 and 12 in a resonance frequency band f2 of 5 GHz. Namely, the provision of the T-shaped passive element 13 improves the isolation characteristic between the first and second antenna elements 11 and 12.

Furthermore, by setting, to f2<f1, the relationship between the first resonance frequency band (f1=5 GHz band) of the first and second antenna elements 11 and 12, and the second resonance frequency band (f2=2.5-3 GHz band) of the passive element 13, the VSWR and radiation efficiency in the vicinity of the lower resonance frequency band f2 (2.5-3 GHz band) can be improved.

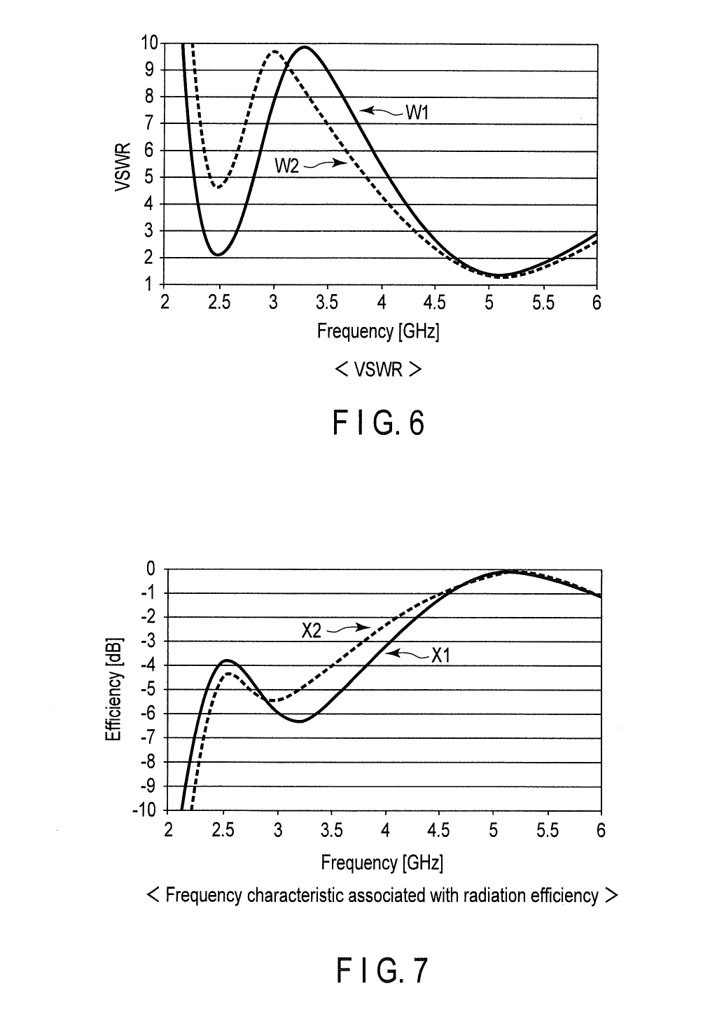

FIG. 6 is a graph illustrating a comparison result between the VSWR characteristic W1 of the antenna device of the first embodiment obtained when no mismatch loss is considered, and the VSWR characteristic W2 of an antenna device with no T-shaped passive element 13. From this figure, it can be understood that the antenna device of the first embodiment exhibits a improved VSWR. Similarly, FIG. 7 is a graph illustrating a comparison result between the radiation efficiency characteristic X1 of the antenna device of the first embodiment obtained when no mismatch loss is considered, and the radiation efficiency characteristic X2 of an antenna device with no T-shaped passive element 13. From this figure, it can be understood that the antenna device of the first embodiment exhibits a higher radiation efficiency.

In addition, in the first embodiment, the first feed terminal 14 is located near the left edge of the patterned ground 3 to thereby set longer the distance between the terminal 14 and the ground terminal 31. This enables one side of the patterned ground 3 to serve as part of the passive element 13 when part of the antenna current output from the first feed terminal 14 flows along the one side of the patterned ground 3 and then flows into the left branch portion of the element 13 via the common portion of the same, as shown in a current path. Therefore, when the feed element 13 is made to resonate with the above-mentioned second frequency band (f2=2.5-3 GHz band), the length of the left branch portion of the feed element 13 can be shortened. The same advantage can be obtained in association with the second feed terminal 15. As a result, the antenna device can be reduced in size.

### Second Embodiment

In a second embodiment, the common portion of the passive element 13 is bifurcated in the vicinity of the ground terminal 31 to thereby further enhance the isolation characteristic between the first and second feed terminals 14 and 15.

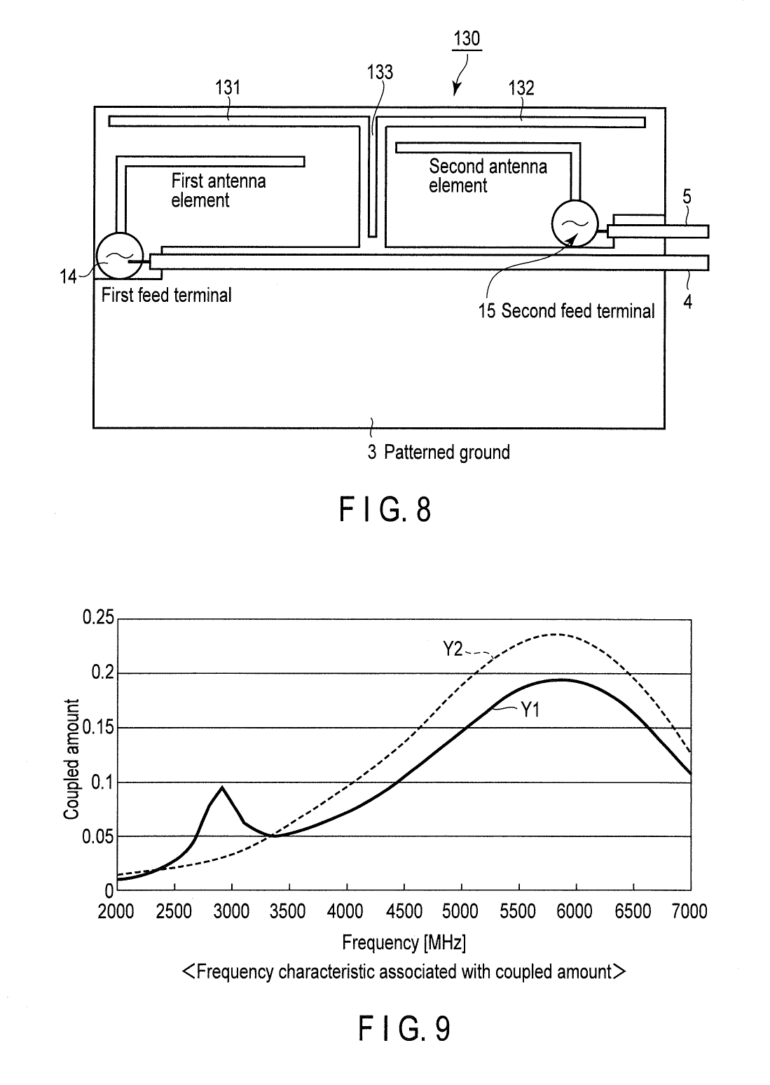

FIG. 8 is a view illustrating the structure of an antenna device according to the second embodiment. In this figure, elements similar to those shown in FIG. 2 are denoted by corresponding reference numbers, and no detailed description will be given thereof.

A passive element 130 is formed of a T-shaped conductive member having a constant width. The T-shaped conductive member has a left branch portion 131 and a right branch portion 132 arranged parallel to the first and second antenna elements 11 and 12, respectively, with a preset gap interposed therebetween, so that the branch portions will be capacitively coupled to the antenna elements.

The common portion of the T-shaped conductive member is bifurcated near the ground terminal 31. The bifurcating processing of the common portion is realized by, for example, forming a slit 133 in the common portion. The slit 133 may be formed to part of the common portion, or up to the patterned ground 3. In the latter case, two ground contacts are provided.

In this structure, the current output from the first feed terminal 14 to the common portion of the passive element 13 is bifurcated by the slit 133 to flow independently. This further enhances the isolation characteristic between the first and second feed terminals 14 and 15.

FIG. 9 is a graph illustrating frequency characteristic associated with a coupled amount, obtained by theoretical analysis using an electromagnetic analysis tool. As shown, a coupled amount Y1 detected where a slit 133 is formed in the common portion of the passive element 13 is greatly suppressed near a high resonance frequency band (f1=5 GHz), compared to a coupled amount Y2 detected where no slit is formed.

### Third Embodiment

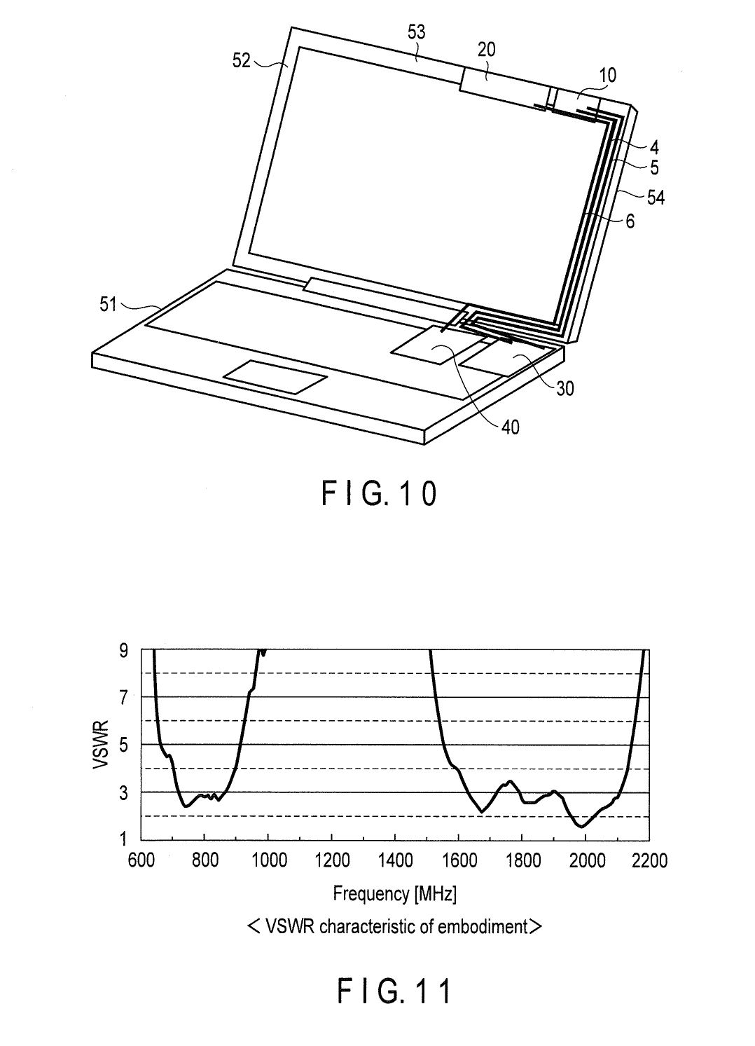

FIG. 10 is a perspective view illustrating an electronic apparatus with an antenna device according to a third embodiment. In FIG. 10, elements similar to those of FIG. 1 are denoted by corresponding reference numbers, and no detailed description will be given thereof.

First and second wireless circuits 30 and 40 are contained in the lower housing 51 of an electronic apparatus 50 comprising a notebook personal computer. On the other hand, a MIMO antenna device 10 and a second antenna device 20 are arranged side by side on the upper portion 53 of the frame-shaped upper housing 52. The MIMO antenna device 10 is positioned closer to an end of the upper portion 53 of the upper housing 52, and the second antenna device 20 is positioned closer to the center of the upper portion 53 of the upper housing 52.

The MIMO antenna device 10 is used as a transceiver for, for example, a wireless LAN (local area network), and has the same structure as the antenna device shown in FIG. 2. Namely, in the MIMO antenna device 10, the first and second RF cables 4 and 5 are led in the same direction from the first and second feed terminals 14 and 15 parallel to each other. Further, by stepwise forming one side of the patterned ground 3, both the first and second RF cables 4 and 5 are extended on the patterned ground 3. The first and second RF cables 4 and 5 are extended along one side 54 of the upper housing 52 and connected to the first wireless circuit 30.

The second antenna device 20 is used for, for example, 3G/LTE, and includes, for example, a single monopole antenna element or folded monopole antenna element. A third RF cable 6 is led out of a third feed terminal connected to the antenna element, extended in parallel with the first and second RF cables 4 and 5 along the above-mentioned side 54 of the upper housing 52, and connected to the second wireless circuit 40.

Since as described above, the MIMO antenna device 10 is positioned closer to the above-mentioned end of the upper portion 53 of the upper housing 52, and the second antenna device 20 is positioned closer to the center of the upper portion 53 of the upper housing 52, the first and second RF cables 4 and 5 can be extended without being passed over the second antenna device 20. This enables the second antenna device 20 to be free from the influence of the first and second RF cables 4 and 5, whereby occurrence of unnecessary resonance on the second antenna device 20 can be suppressed.

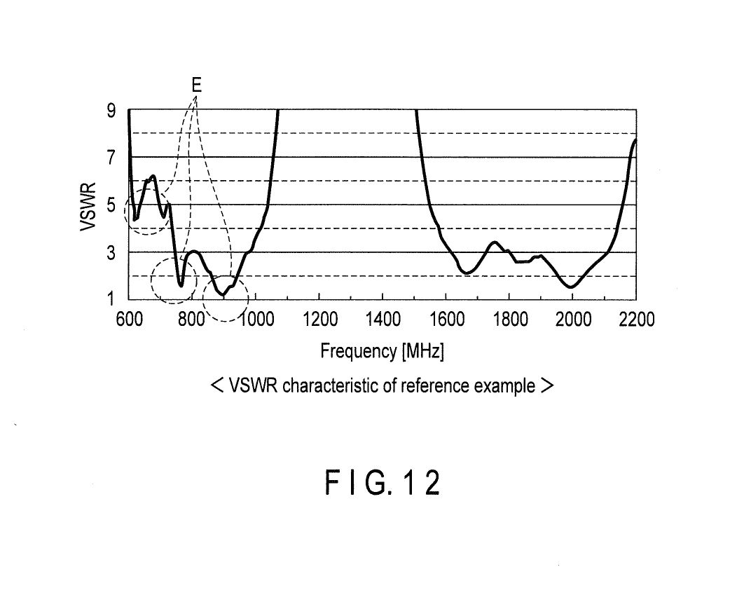

FIG. 11 shows an example of the VSWR characteristic of the second antenna element 20. From this figure, it can be understood that occurrence of unnecessary resonance in a low frequency band (800 MHz band) is suppressed. FIG. 12 shows the VSWR characteristic of the second antenna element 20 obtained in a reference example where the MIMO antenna device 10 is positioned closer to the center of the upper portion 53, and the second antenna device 20 is positioned closer to an end of the upper portion 53, thereby extending the first and second RF cables 4 and 5 on the antenna device 20. From this figure, it can be understood that unnecessary resonance occurs in a low frequency band (800 MHz band). The occurrence of unnecessary resonance E makes it difficult to satisfy a desired radiation characteristic in the 800 MHz zone of the wireless WAN, whereby authentication procedure determined by wireless carriers may not be cleared.

### Other Embodiments

Although the above-described embodiments employ a structure in which the open ends of the first and second antenna elements 11 and 12 in the form of an inverted L face each other with the T-shaped passive element 13 interposed therebetween, the open ends may have the same orientation or opposite orientations. Further, although in the embodiments, the antenna device(s) receives wireless LAN signals, it may receive terrestrial digital radio broadcasting signals, or signals sent from other systems, such as fire-prevention broadcasting signals sent from an automonous body.

In addition, the antenna elements incorporated in the MIMO antenna device 10 and the second antenna device 20 may be changed in type, number, structure and size, and the first and second antenna devices in the housing of an electronic device may be changed in arrangement, orientation, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna device for use in an electronic device comprising a wireless circuit unit, a patterned ground providing a ground potential, and a first feed point and a second feed point arranged along a side of the patterned ground with a predetermined distance therebetween, comprising:
a first antenna element comprising a first end connected to the first feed point and a second end kept open, a part of the first antenna element comprising the open second end being positioned parallel to the side of the patterned ground;
a second antenna element adjacent to the first antenna element along the side of the patterned ground, and comprising a first end connected to the second feed point and a second end kept open, a part of the second antenna element comprising the open second end being positioned parallel to the side of the patterned ground;
a T-shaped passive element comprising a common portion, and a first branch portion and a second branch portion branching off from the common portion, an end of the common portion being connected to the patterned ground between the first and second feed points, the first and second branch portions being positioned to be able to be capacitively coupled to the respective parts of the first and second antenna elements comprising the second ends;
a first high-frequency cable connecting the first feed point to the wireless circuit unit; and
a second high-frequency cable connecting the second feed point to the wireless circuit unit,
wherein the first and second high-frequency cables are led in a same direction from the first and second feed points, respectively, along the side of the patterned ground, and the first high-frequency cable is extended on the patterned ground.

2. The antenna device of claim 1, wherein
the first and second feed points are provided on ends of the side of the patterned ground; and
the first and second antenna elements comprise the first and second ends thereof connected to the first and second feed points, and comprise the open second ends thereof opposed to each other with the common portion of the passive element interposed therebetween.

3. The antenna device of claim 1, wherein the common portion of the passive element branches at a ground end of the common portion or at a part of the common portion, and branch portions resulting from branching are located at a predetermined distance from each other.

4. The antenna device of claim 1, wherein the first and second antenna elements have lengths that enable the first and second antenna elements to resonate with a first resonance frequency band, and the passive element comprise a length that enables the passive element to resonate with a second resonance frequency band lower than the first resonance frequency band.

5. An electronic device comprising a wireless circuit unit, a patterned ground providing a ground potential, a first feed point and a second feed point arranged along a side of the patterned ground with a predetermined distance therebetween, and a first antenna device,
the first antenna device comprising:
a first antenna element comprising a first end connected to the first feed point and a second end kept open, a part of the first antenna element comprising the open second end being positioned parallel to the side of the patterned ground;
a second antenna element adjacent to the first antenna element along the side of the patterned ground, and comprising a first end connected to the second feed point and a second end kept open, a part of the second antenna element comprising the open second end being positioned parallel to the side of the patterned ground;
a T-shaped passive element comprising a common portion, and a first branch portion and a second branch portion branching off from the common portion, an end of the common portion being connected to the patterned ground between the first and second feed points, the first and second branch portions being able to be capacitively coupled to the respective parts of the first and second antenna elements comprising the second ends;
a first high-frequency cable connecting the first feed point to the wireless circuit unit; and
a second high-frequency cable connecting the second feed point to the wireless circuit unit,
wherein the first and second high-frequency cables are led in a same direction from the first and second feed points, respectively, along the side of the patterned ground, and the first high-frequency cable is extended on the patterned ground.

6. The electronic device of claim 5, further comprising a frame-shaped housing, a second antenna device that resonates with a third frequency band lower than the first and second frequency bands, a second wireless circuit unit, a third high-frequency cable to connect a third feed point connected to the second antenna device, to the second wireless circuit unit,
wherein
the first antenna device is located on an end of a first side of the frame-shaped housing, or on a portion of the first side near the first side;
the second antenna device is located on a portion of the first side closer to a center of the first side than the first antenna device;
the first and second high-frequency cables are led from the first and second feed points along the first side of the housing away from the second antenna device;
the third high-frequency cable is led from the third feed point along the first side of the housing toward the first antenna device; and
the first, second and third high-frequency cables led out are extended parallel to each other on a second side of the housing adjacent to the first side, and are connected to the first and second wireless circuit units.

7. An electronic device comprising:
a wireless circuit unit;
a patterned ground providing a ground potential;
an L-shaped first antenna element comprising a first end connected to a first feed point, and a second end kept open;
an L-shaped second antenna element adjacent to the first antenna element along a side of the patterned ground, and comprising a first end connected to a second feed point, and a second end kept open;
a T-shaped passive element comprising a common portion, and a first branch portion and a second branch portion branching off from the common portion and perpendicular to the common portion, an end of the common portion being connected to the patterned ground between the first and second feed points, the first and second branch portions being parallel to parts of the first and second antenna elements such that the first and second branch portions are permitted to be capacitively coupled to the parts of the first and second antenna elements.
